(19) United States
(12) Patent Application Publication
(10) Pub. No.: US 2015/0221123 A1
(43) Pub. Date: Aug. 6, 2015

(54) SYSTEM AND METHOD FOR COMPUTING GATHERS USING A SINGLE-INSTRUCTION MULTIPLE-THREAD PROCESSOR

(71) Applicant: Nvidia Corporation, Santa Clara, CA (US)

(72) Inventors: Peter-Pike Sloan, Sammamish, WA (US); Chris Wyman, Redmond, WA (US)

(73) Assignee: Nvidia Corporation, Santa Clara, CA (US)

(21) Appl. No.: 14/170,937

(22) Filed: Feb. 3, 2014

(51) Int. Cl. G06T 15/06; G06F 9/38

(52) U.S. Cl. CPC G06T 15/06; G06F 9/38; G06T 2200/04

(57) ABSTRACT

Systems for, and methods of, computing gathers for processing on a SIMT processor. In one embodiment, the system includes: (1) a thread group creator executing on a processor and operable to assign ray traces pertaining to a single receiver to threads for execution by a SIMT processor and (2) a memory configured to contain at least some of the threads for execution by the SIMT processor.

### TECHNICAL FIELD

This application is directed, in general, to a graphics processing and, more specifically, to a system and method for computing ray-traced gathers using a single-instruction multiple-thread (SIMT) processor.

### BACKGROUND

As those skilled in the pertinent art are aware, many applications, or programs, may be executed in parallel, often in a pipeline, to increase their performance. Gathering ray traces representing the incidence of light upon, or visibility of, a point on a surface or a free point in space is a common problem in graphics processing. Gathering, or computing gathers, is typically performed, for example, during the precomputing (“offline baking,” or simply “baking”) of lightmaps or precomputed visibility (e.g., ambient occlusion, obscurance or higher-order variants.) Gathering may advantageously be carried out in parallel by performing the same sequence of actions on multiple points (also called “receiver locations”) concurrently.

A SIMT processor is particularly adept at executing data parallel programs (programs that carry out the same instruction on multiple data concurrently). A control unit in the SIMT processor creates groups of threads of execution (also called “warps”) and schedules them for execution, during which all threads in the group execute the same instruction concurrently. In one particular processor, each group has 32 threads, corresponding to 32 execution pipelines, or lanes, in the SIMT processor.

### SUMMARY

One aspect provides a system for computing gathers. In one embodiment, the system includes: (1) a thread group creator executing on a processor and operable to assign ray traces pertaining to a single receiver to threads for execution by a SIMT processor and (2) a memory configured to contain at least some of the threads for execution by the SIMT processor.

Another embodiment includes: (1) a thread group creator executing on a processor and operable to assign ray traces pertaining to a single receiver to threads for execution by a SIMT processor and (2) a coherence sorter associated with the thread group creator and operable to sort the ray traces among the threads to decrease dispersion angles among ray traces in each of the threads.

Another aspect provides a method of computing gathers. In one embodiment, the method includes: (1) creating a thread group of ray traces pertaining to a single receiver location and (2) causing the thread group to be processed concurrently in a SIMT processor.

### BRIEF DESCRIPTION

Reference is now made to the following descriptions taken in conjunction with the accompanying drawings, in which:

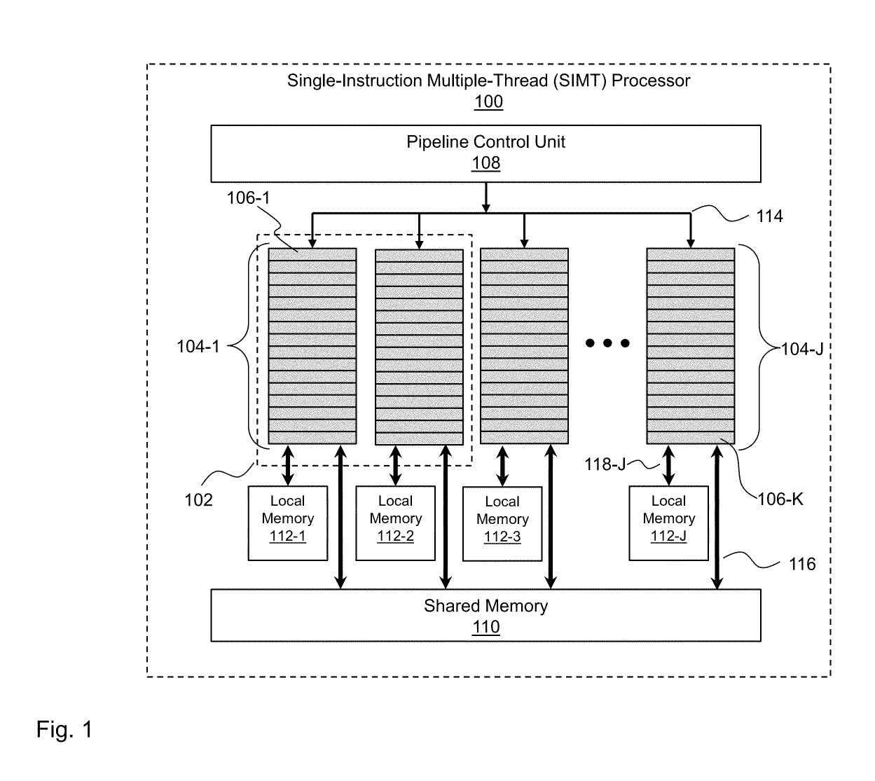

FIG. 1 is a block diagram of one embodiment of a SIMT processor;

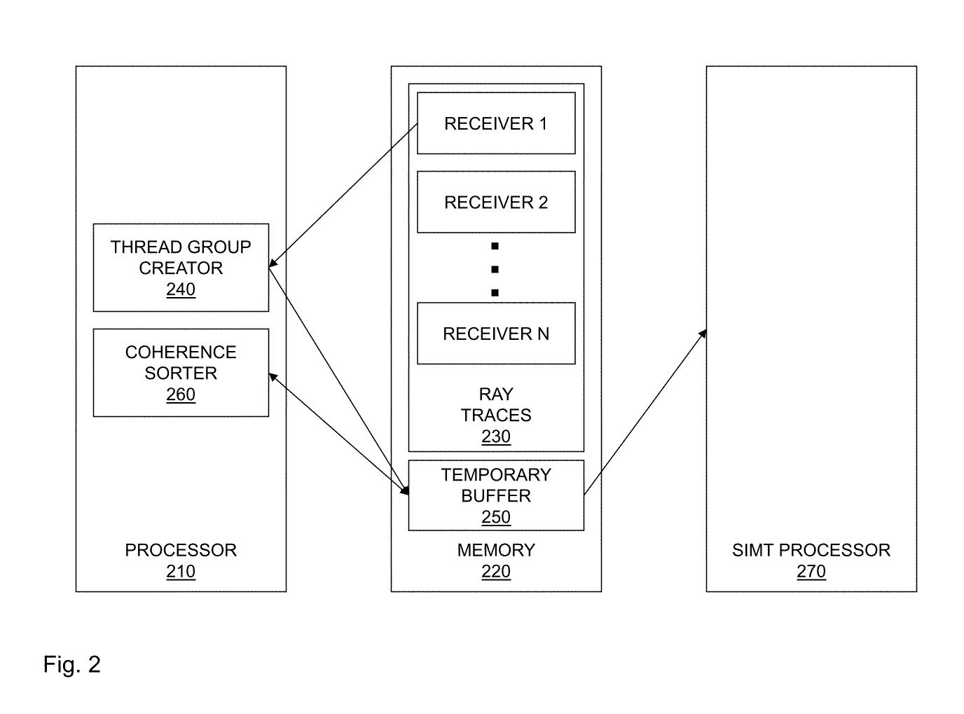

FIG. 2 is a block diagram of one embodiment of a system for computing gathers; and

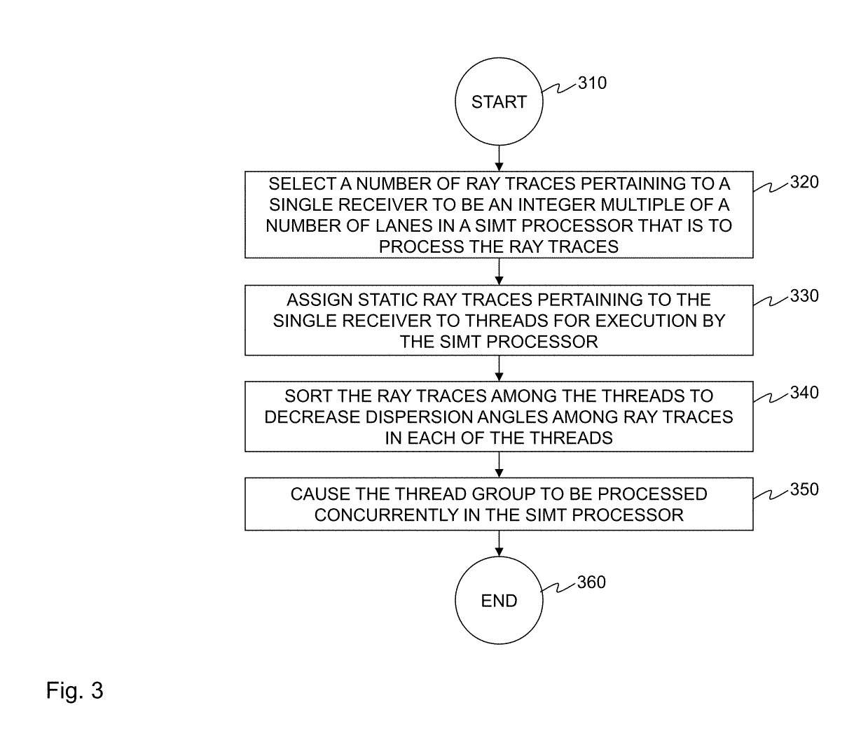

FIG. 3 is a flow diagram of one embodiment of a method of computing gathers.

### DETAILED DESCRIPTION

As stated above, gathering may advantageously be carried out in parallel by performing the same sequence of actions on multiple receiver locations, a function that a SIMT processor can perform adeptly. Because gathering is a data-parallel operation, an intuitive way to compute gathering is to create a thread group in which each thread contains ray traces pertaining to a different receiver location.

However, it is realized herein that grouping ray traces in this manner is inefficient. It is further realized herein that a group should contain ray traces pertaining to only a single receiver location, such that ray traces pertaining to only that single receiver location are processed concurrently.

It is still further realized that computational efficiency may be increased further by reordering the ray traces within the thread group. More specifically, it is realized that reordering the ray traces such that their coherence is increased is advantageous. Ideally, the ray traces can be reordered to maximize their coherence, but efficiency is gained even in the absence of maximization.

It is yet further realized that dispersion (i.e., cone) angle provides a useful metric for coherence. Thus, the ray traces can be reordered such that those in each thread have closely-related dispersion angles.

Accordingly, introduced herein are various embodiments of a system and method for computing gathers using a SIMT processor in which each thread group in which the gathers are processed contains ray traces pertaining only to a single receiver. This novel grouping technique may be thought of as “interleaved gathering.” Some embodiments further process the ray traces in an order that is based on coherence among the traces. In specific embodiments, coherence is expressed in terms of dispersion angle. Certain embodiments of the system and method provide a substantial improvement in computational efficiency with no loss of accuracy. Although the system and method will be described in detail in the context of computing ambient obscurance on surfaces and in volumes (represented in quadratic spherical harmonics), the system and method have substantial additional applications. For example, lightmap baking has been found to benefit from processing according to the system and method. While the system and method may be used with respect to static, semi-static or dynamic ray traces, certain embodiments to be described in greater detail herein are used with respect to static ray traces.

Before describing various embodiments of the system and method, the architecture of an embodiment of a SIMT processor will generally be described. FIG. 1 is a block diagram of a SIMT processor 100 operable to contain or carry out a system or method for executing sequential code using a group of threads. SIMT processor 100 includes multiple thread processors, or cores 106, organized into thread groups 104, or “warps.” SIMT processor 100 contains J thread groups 104-1 through 104-J, each having K cores 106-1 through 106-K. In certain embodiments, thread groups 104-1 through 104-J may be further organized into one or more thread blocks 102. One specific embodiment has thirty-two cores 106 per thread group 104. Other embodiments may include as few as four cores in a thread group and as many as several tens of thousands. Certain embodiments organize cores 106 into a single thread group 104, while other embodiments may have hundreds or even thousands of thread groups 104. Alternate embodiments of SIMT processor 100 may organize cores 106 into thread groups 104 only, omitting the thread block organization level.

SIMT processor 100 further includes a pipeline control unit 108, shared memory 110 and an array of local memory 112-1 through 112-J associated with thread groups 104-1 through 104-J. Pipeline control unit 108 distributes tasks to the various thread groups 104-1 through 104-J over a data bus 114. Pipeline control unit 108 creates, manages, schedules, executes and provides a mechanism to synchronize thread groups 104-1 through 104-J. Certain embodiments of SIMT processor 100 are found within a graphics processing unit (GPU).

Having described the architecture of an embodiment of a SIMT processor, more detail will be given regarding irradiance maps, which may ultimately contain data processed according to various embodiments of the disclosed system or method. In one embodiment, the output of the system or the method is employed to populate a precomputed irradiance map for which irradiance is gathered naively at each texel using an ray tracer based on the known Optix ray tracing software program (see, Parker, et al., “Optix: A General Purpose Ray Tracing Engine,” ACM Transactions on Graphics, August 2010, incorporated herein by reference) and then compressed. In another embodiment, the system or method is employed to populate a more sophisticated and efficient irradiance map in which the irradiance map is first decomposed into coarse basis functions, and illumination is gathered only once per basis. The latter irradiance map requires an order of magnitude fewer rays for comparable performance, accelerating computation sufficiently to allow multiple updates of the entire irradiance map per second.

In yet another embodiment, the system and method illustrated herein are employed to create an irradiance map in the context of cloud-based rendering. Such an irradiance map may be created by:

1. offline generating global unique texture parameterization;

2. offline clustering texels into basis functions;

3. gathering indirect light at each basis function or texel;

4. reconstructing per-texel irradiance from basis functions;

5. encoding irradiance maps (e.g., to H.264) and transmitting the irradiance maps from the cloud to a client;

6. decoding the irradiance maps at the client; and

7. rendering direct light and using the irradiance maps for indirect light.

As stated above, certain embodiments to be described in greater detail herein are used with respect to static ray traces, i.e. gathering using a static, precomputed set of ray directions. Gathering is relatively common in offline baking tools, and randomization can be done using random rotations of direction sets or progressive sets of points. The most straightforward way to implement gathering in Optix is to compute the value at each receiver in the ray generation program (so gather all of the rays for a given point in a given lane.)

The novel technique embodied in the system and method disclosed herein involves a pass through the ray traces in which all lanes in a thread group are forced to work on the same receiver. While this technique works optimally when the number of ray traces pertaining to the receiver is an integer multiple of the number of lanes in the processor, the technique is generally applicable irrespective of the relationship between the number of ray traces and the number of lanes. In Optix, a second pass may be required to compute a reduction over results across a thread group or atomic instructions that would have significant conflicts. Some of the data being collected, e.g., minimum hit distance, may require emulation using computer-aided simulation. See results set forth below, in which a second pass is used to compute the reduction. In one embodiment, the ray tracing is done in batches, and a temporary buffer is established for the second pass having a size equaling the number of lanes in the SIMT processor multiplied by the number of receivers.

Hammersly points (see, e.g., Weisstein, “Hammersley Point Set,” From MathWorld—A Wolfram Web Resource, http://mathworld.wolfram.com/HammersleyPointSet.html) are known to have a natural structure amounting to equatorial bands around the sphere (in the case of a point in free space) or a hemisphere (in the case of a point on a surface). Other quasi-Monte Carlo (QMC) sequences tend to be less coherent. When the ray-tracing is not interleaved, sorting has been found not to change the results, perhaps because caches associated with the SIMT processor are not large enough to have any coherence between rays traced on a single lane.

At a high level, the ray traces assigned between or among multiple lanes should have as much coherence as possible. In the illustrated embodiment, the ray traces should have as tight an angular bound as possible. Vector quantization (VQ) may be used on the sphere (using, e.g., geodesic distance to determine which cluster a sample should be in, and Euclidean distance and renormalization to compute a representative for a cluster.) This does not guarantee a thread group width of points per cluster though. An algorithm, which may be a simple, greedy algorithm, may then be executed to force every cluster to have a thread group width number of ray traces. One approach to such algorithm is to find the most imbalanced cluster and distribute ray traces to clusters that have not been “processed,” repeating until all of the clusters have the correct number. This can result in clusters processed when all of their direct neighbors are “locked,” causing it to grab samples from more distant clusters. Later passes may be employed to improve on this result by finding points that can be optimally swapped with other clusters, to decrease both the VQ error and the cone angle.

Turning to FIG. 2, illustrated is a block diagram of one embodiment of a system for computing gathers. Shown are a processor 210 in which thread groups are created and a memory 220 in which ray traces 230 pertaining to multiple receivers (i.e. Receiver 1, Receiver 2, . . . , Receiver N) constituting a scene are stored. Ray traces pertaining to only one receiver (e.g., Receiver 1) are prepared for processing by being received into a thread group creator 240 executing on the processor 210. The thread group creator 240 is operable to employ a temporary buffer 250 to assign the various ray traces to SIMT processor threads (i.e. SIMT processor lanes). A coherence sorter 270 is operable to sort the ray traces among the lanes to increase their coherency. In one embodiment, the coherence sorter 270 is operable to sort the ray traces such that dispersion (or cone) angles are reduced in each given lane. Finally, the thread group so created is provided to a SIMT processor 270 for processing. The ray traces pertaining to another receiver (e.g., Receiver 2) may then be employed to create a separate thread group for separate (e.g., subsequent) processing in the SIMT processor 280.

FIG. 3 is a flow diagram of one embodiment of a method of computing gathers. The method begins in a start step 310. In a step 320, a number of ray traces pertaining to a single receiver is selected to be an integer multiple of a number of lanes in the SIMT processor that is to process the ray traces. In one embodiment, the SIMT processor has 32 lanes, so the thread group will have 32 threads for processing a number of ray traces that is an integer multiple of 32. In a step 330, the ray traces pertaining to the single receiver are assigned to threads for execution by the SIMT processor. In a step 340, the ray traces are sorted among the threads to decrease dispersion angles among the ray traces in each given one of the threads. In a step 350, the thread group is caused to be processed concurrently in the SIMT processor. The method ends in an end step 360.

Some example results will now be given for an embodiment of the system or method described herein to produce lightmaps on a SIMT processor having 32 lanes. In the example, ambient obscurance is to be computed for two different radii. Some of the objects in the scene (e.g., trees and large bushes) are treated as partial visibility occluders, and other small detailed objects are treated as “visibility fog.” Each gather ray computes the modification from these detail objects after finding the closest ray intersection. Statistics on whether or not each object has a back face are also stored, along with the minimum distance for all gather rays.

There are 6,740,348 receivers distributed over the surfaces of the objects in the scene. Each of the receivers gather using 256 directions (an integer multiple of 32) shooting two rays—first a closest hit against the static geometry and then against the decorator geometry that modifies the visibility. The first type of volume data are 11,892 locations that are near the large occluders, and the second set of 234,582 locations are based on sampling using visibility regions inside the playable area for the level. There are 1.5 million vertices and 1.7 million faces for the static part of the scene, 149,000 vertices and 234,000 faces for the flattened trees and 7902 total instances (trees plus grass and shrubs.)

Two tables will now be presented to compare example performances. Each table relates a baseline technique (a conventional technique in which each lane of a SIMT processor processes ray traces pertaining to a separate receiver), an interleaved technique (in which a thread group contains ray traces pertaining to only one receiver, but no coherence sorting has been performed) and an interleaved technique in which coherence sorting has been performed. All three techniques happen to use Hammersly points as the ray traces for the receivers. However, this need not be the case. Table 1 represents the performance of a Quadro™ K5000™ based on a GK104™ SIMT GPU, commercially available from Nvidia Corporation of Santa Clara, Calif. Table 2 represents the performance of a Tesla™ K20™ based on a GK110™ SIMT GPU, also commercially available from Nvidia Corporation. Times are given in seconds.

TABLE 1
Performance on the Quadro ™ K5000 ™

| | | Interleaved/% of | Interleaved + sort/% |
|---|---|---|---|
| K5000 | Baseline | Baseline | of Baseline |
| Surface | 124.348 | 104.125/83.7% | 91.053/73.2% |
| Volume A | 2.3112 | 1.49095/64.5% | 1.253/54.2% |
| Volume B | 20.0415 | 19.5373/97.5% | 17.483/87.2% |

TABLE 2
Performance with the Tesla ™ K20 ™

| | | Interleaved/% of | Interleaved + sort/% |
|---|---|---|---|
| K20 | Baseline | Baseline | of Baseline |
| Surface | 66.637 | 52.157/78.3% | 44.951/67.5% |
| Volume A | 1.605 | 0.835/52% | 0.699/43.6% |
| Volume B | 11.669 | 10.373/88.9% | 8.556/73.3% |

Those skilled in the art to which this application relates will appreciate that other and further additions, deletions, substitutions and modifications may be made to the described embodiments.

What is claimed is:

1. A system for computing gathers, comprising:
a thread group creator executing on a processor and operable to assign ray traces pertaining to a single receiver to threads for execution by a single-instruction multiple-thread (SIMT) processor; and
a memory configured to contain at least some of said threads for execution by said SIMT processor.

2. The system as recited in claim 1 further comprising a coherence sorter associated with said thread group creator and operable to sort said ray traces among said threads to increase a coherency thereof.

3. The system as recited in claim 2 wherein said coherence sorter is operable to sort said ray traces to reduce dispersion angles thereamong.

4. The system as recited in claim 1 wherein said ray traces are Hammersly points.

5. The system as recited in claim 1 wherein a number of said ray traces pertaining to said single receiver is selected to be an integer multiple of a number of lanes in said SIMT processor.

6. The system as recited in claim 1 wherein said memory contains said ray traces in a temporary buffer therein.

7. A method of computing gathers, comprising:
creating a thread group of ray traces pertaining to a single receiver location; and
causing said thread group to be processed concurrently in a single-instruction, multiple-thread (SIMT) processor.

8. The method as recited in claim 7 further comprising reordering said ray traces to increase a coherence thereof in at least one thread of said thread group.

9. The method as recited in claim 8 further comprising reordering said ray traces to increase said coherence thereof in all threads of said thread group.

10. The method as recited in claim 9 further comprising reordering said ray traces to maximize said coherence thereof in said all threads.

11. The method as recited in claim 8 wherein said coherence is based on dispersion angle.

12. The method as recited in claim 7 further comprising selecting a number of said ray traces pertaining to said single receiver to be an integer multiple of a number of lanes in said SIMT processor.

13. The method as recited in claim 7 further comprising storing said ray traces in a temporary buffer in a memory.

15. A system for computing gathers, comprising:
a thread group creator executing on a processor and operable to assign ray traces pertaining to a single receiver to threads for execution by a single-instruction multiple-thread (SIMT) processor; and
a coherence sorter associated with said thread group creator and operable to sort said ray traces among said threads to decrease dispersion angles among ray traces in each of said threads.

16. The system as recited in claim 15 wherein said ray traces are Hammersly points.

17. The system as recited in claim 15 wherein a number of said ray traces pertaining to said single receiver is selected to be an integer multiple of a number of lanes in said SIMT processor.

18. The system as recited in claim 15 wherein said memory contains said ray traces in a temporary buffer therein.

19. The system as recited in claim 15 wherein said system is embodied in a general-purpose central processing unit and said SIMT processor is a graphics processing unit.

20. The system as recited in claim 15 wherein said SIMT processor has 32 lanes.
